(19) United States
(12) Patent Application Publication
(10) Pub. No.: US 2020/0051052 A1
(43) Pub. Date: Feb. 13, 2020

(54) PAYMENT SYSTEM, PAYMENT METHOD, AND PROGRAM

(71) Applicant: Rakuten, Inc., Tokyo (JP)

(72) Inventors: Tsuyoshi KIMURA, Setagaya-ku, Tokyo (JP); Hideki AKASHIKA, Setagaya-ku, Tokyo (JP); Seiichi SHIBAMOTO, Setagaya-ku, Tokyo (JP)

(21) Appl. No.: 16/344,795

(22) PCT Filed: Oct. 26, 2016
(86) PCT No.: PCT/JP2016/081744

§ 371 Date: Apr. 24, 2019

(51) Int. Cl. G06Q 20/20; G06Q 20/32

(52) U.S. Cl. CPC G06Q 20/204; G06Q 20/327

(57) ABSTRACT

To simplify the configuration for achieving payment with a high degree of freedom in or near a shop, position information acquisition means of a payment system acquires shop terminal position information for indicating a position of a shop terminal and customer terminal position information for indicating a position of a portable customer terminal on which a customer performs a payment operation. Determination means determines, when the payment operation is performed on the customer terminal, whether a distance between the position of the shop terminal indicated by the shop terminal position information and the position of the customer terminal indicated by the customer terminal position information is smaller than a threshold value. Pay lent processing execution means is executable for payment processing based on a result of determination made by the determination means.

### TECHNICAL FIELD

The present invention relates to a payment system, a payment method, and a program.

### BACKGROUND ART

In recent years, a technology of enabling a customer to settle payment by operating his or her own terminal has been discussed along with development of an information processing technology. For example, in Patent Literature 1, there is described a system configured to: display, on a display unit of a vending machine arranged in, for example, a recipient shop, a two-dimensional code containing information on, for example, the shop; and use a credit card registered in a server to settle the payment when the customer uses a customer terminal, for example, a smartphone, to read the two-dimensional code. Further, for example, in Patent Literature 2, there is described a system configured to determine whether or not latitude/longitude information on a mobile POS terminal falls within a range of a site of a shop, and control whether or not to allow payment based on the result of determination, to thereby prevent illegal payment at a location that cannot be monitored.

### CITATION LIST

### Patent Literature

[PTL 1] JP 4417226 B2

[PTL 2] JP 5788126 B2

### SUMMARY OF INVENTION

### Technical Problem

With the technology described above, payment is based on the assumption that there is a customer in or near the shop. In this respect, in the technology of Patent Literature 1, the customer is required to approach a vending machine to photograph a two-dimensional code, and the payment is not always allowed to be settled at a desired location in the shop, resulting in a large restriction in terms of location and inconvenience for the customer. The mobile POS terminal of Patent Literature 2 is portable, and thus has a higher degree of freedom in terms of location than that of Patent Literature 1. However, the shape and width of the site differ depending on the shop, and thus, in Patent Literature 2, information that defines a range enabling payment is required to be prepared for each shop, and management of information is extremely complicated. As a result, in the technology of Patent Literature 2, the configuration for achieving payment with a high degree of freedom in or near a shop becomes complicated.

The present invention has been made in view of the above-mentioned problem, and has an object to simplify the configuration for achieving payment with a high degree of freedom in or near a shop.

### Solution to Problem

In order to solve the above-mentioned problem, a payment system according to one embodiment of the present invention includes: position information acquisition means for acquiring shop terminal position information for indicating a position of a shop terminal and customer terminal position information for indicating a position of a portable customer terminal on which a customer performs a payment operation; determination means for determining, when the payment operation is performed on the portable customer terminal, whether a distance between the position of the shop terminal indicated by the shop terminal position information and the position of the portable customer terminal indicated by the customer terminal position information is smaller than a threshold value; and payment processing execution means executable for payment processing based on a result of determination made by the determination means.

A payment method according to one embodiment of the present invention includes: a position information acquisition step of acquiring shop terminal position information for indicating a position of a shop terminal, and customer terminal position information for indicating a position of a portable customer terminal, on which a customer performs a payment operation; a determination step of determining, when the payment operation is performed on the portable customer terminal, whether a distance between the position of the shop terminal indicated by the shop terminal position information and the position of the portable customer terminal indicated by the customer terminal position information is smaller than a threshold value; and a payment processing execution step executable of payment processing based on a result of determination made in the determination step.

A program according to one embodiment of the present invention causes a computer to function as: position information acquisition means for acquiring shop terminal position information for indicating a position of a shop terminal, and customer terminal position information for indicating a position of a portable customer terminal, on which a customer performs a payment operation; determination means for determining, when the payment operation is performed on the portable customer terminal, whether a distance between the position of the shop terminal indicated by the shop terminal position information and the position of the portable customer terminal indicated by the customer terminal position information is smaller than a threshold value; and payment processing execution means executable for payment processing based on a result of determination made by the determination means.

Further, an information storage medium according to one embodiment of the present invention is a computer-readable information storage medium having the above-mentioned program stored thereon.

Further, in one aspect of the present invention, the payment processing execution means is configured to allow execution of the payment processing when the determination means determines that the distance is smaller than the threshold value, and prohibit execution of the payment processing when the determination means determines that the distance is equal to or larger than the threshold value.

Further, in one aspect of the present invention, the payment processing execution means is configured to allow execution of the payment processing when the determination means determines that the distance is smaller than the threshold value, and hold execution of the payment processing when the determination means determines that the distance is equal to or larger than the threshold value, the payment system further includes notification means for issuing a predetermined notification on at least one of the shop terminal or the portable customer terminal when execution of the payment processing is held by the payment processing execution means, the at least one of the shop terminal or the portable customer terminal is configured to receive an approval operation or a denial operation for the held payment processing when the predetermined notification is issued by the notification means, and the payment processing execution means is configured to allow execution of the held payment processing when the approval operation is received, and prohibit execution of the held payment processing when the denial operation is received.

Further, in one aspect of the present invention, the payment operation includes an operation of selecting a recipient shop from among a plurality of shops, the position information acquisition means is configured to acquire the shop terminal position information on the recipient shop selected by the payment operation, the determination means is configured to determine whether a distance between a position of the shop terminal of the recipient shop selected by the payment operation and the position of the portable customer terminal is smaller than the threshold value, and the payment processing execution means is executable for payment processing for the recipient shop selected by the payment operation.

Further, in one aspect of the present invention, the shop terminal is configured to display code information for identifying the shop on display means, the payment operation includes an operation for causing reading means of the portable customer terminal to read the code information displayed on the display means, the position information acquisition means is configured to acquire the shop terminal position information on the shop indicated by the code information read through the payment operation, the determination means is configured to determine whether a distance between a position of the shop terminal of the shop indicated by the code information read through the payment operation and the position of the portable customer terminal is smaller than the threshold value, and the payment processing execution means is executable for payment processing for the shop indicated by the code information read through the payment operation.

Further, in one aspect of the present invention, the shop terminal and the portable customer terminal each include a GPS sensor, and the position information acquisition means is configured to acquire, as the shop terminal position information, position information detected by the GPS sensor of the shop terminal, and acquire, as the customer terminal position information, position information detected by the GPS sensor of the portable customer terminal.

Further, in one aspect of the present invention, the payment system further includes threshold value determination means for determining the threshold value based on an intensity of a signal received by the GPS sensor of the shop terminal and an intensity of a signal received by the GPS sensor of the portable customer terminal.

Further, in one aspect of the present invention, the shop terminal and the portable customer terminal each include at least one type of position detection means, and the payment system further includes threshold value determination means for determining the threshold value based on a type of the position detection means of the shop terminal, which has detected the shop terminal position information, and a type of the position detection means of the portable customer terminal, which has detected the customer terminal position information.

Further, in one aspect of the present invention, the payment system further includes inquiry means for making an inquiry as to whether to execute the payment processing in at least one of the shop terminal or the portable customer terminal when at least one of the shop terminal position information or the customer terminal position information has failed to be acquired, the at least one of the shop terminal or the portable customer terminal is configured to receive an approval operation or a denial operation for the payment processing when the inquiry means has made an inquiry, and the payment processing execution means is configured to allow execution of the payment processing when the approval operation is received, and prohibit execution of the payment processing when the denial operation is received.

Further, in one aspect of the present invention, the shop terminal and the portable customer terminal are executable to perform short-range wireless communication, the payment system further includes communication executability determination means for determining whether the shop terminal and the portable customer terminal are executable to perform short-range wireless communication when at least one of the shop terminal position information or the customer terminal position information has failed to be acquired, and the payment processing execution means is executable for the payment processing based on a result of determination by the communication executability determination means when at least one of the shop terminal position information or the customer terminal position information has failed to be acquired.

### Advantageous Effects of Invention

According to the embodiments of the present invention, it is possible to simplify the configuration for achieving payment with a high degree of freedom in or near a shop.

### BRIEF DESCRIPTION OF DRAWINGS

FIG. 1 is a diagram for illustrating a hardware configuration of a payment system.

FIG. 2 is a diagram for illustrating transition of a screen after an application is activated.

FIG. 3 is a functional block diagram for illustrating an example of functions to be implemented by a payment system according to a first embodiment of the present invention.

FIG. 4 is a table for showing an example of a shop database.

FIG. 5 is a table for showing an example of a customer database.

FIG. 6 is a flow chart for illustrating an example of processing to be executed by the payment system.

FIG. 7 is a diagram for illustrating transition of a screen in payment by code payment.

FIG. 8 is a functional block diagram in a second embodiment of the present invention.

FIG. 9 is a flow chart for illustrating an example of processing to be executed in the second embodiment.

FIG. 10 is a functional block diagram in modification examples of the present invention.

FIG. 11 is a diagram for illustrating an example of notification by a notification unit.

### DESCRIPTION OF EMBODIMENTS

### 1. First Embodiment

Now, a description is given of an example of a payment system according to an embodiment of the present invention.

[1-1. Hardware Configuration of Payment System]

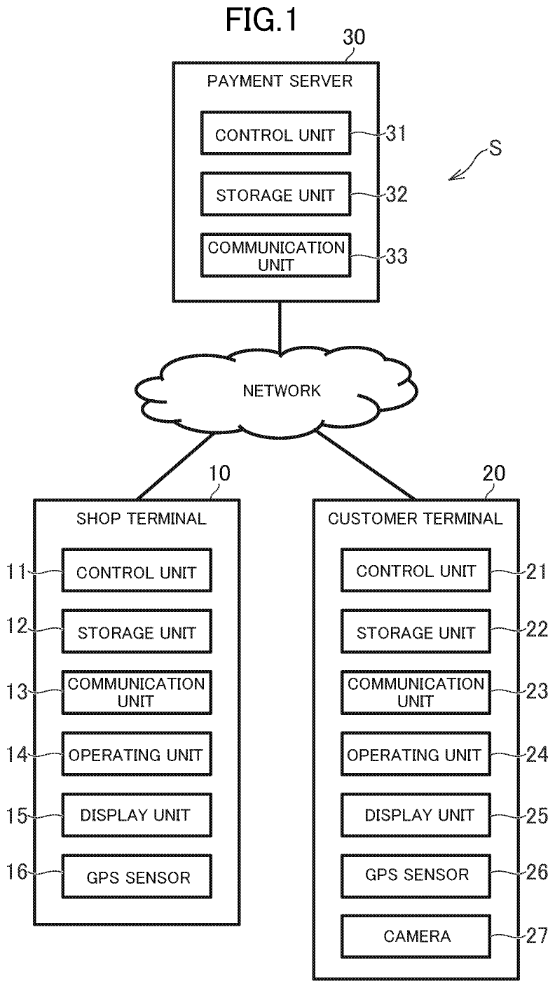

FIG. 1 is a diagram for illustrating a hardware configuration of the payment system. As illustrated in FIG. 1, a payment system S includes a shop terminal 10, a customer terminal 20, and a payment server 30, which are connectable to the Internet or other such network. In FIG. 1, one shop terminal 10, one customer terminal 20, and one payment server 30 are illustrated, but there may be a plurality of shop terminals 10, a plurality of customer terminals 20, and a plurality of payment servers 30.

The shop terminal 10 is a computer to be used in a shop, and examples thereof include a cell phone (including a smartphone), a portable information terminal (including a tablet computer), a POS terminal, and a personal computer. The shop terminal 10 includes a control unit 11, a storage unit 12, a communication unit 13, an operating unit 14, a display unit 15, and a GPS sensor 16.

The control unit 11 includes at least one microprocessor. The control unit 11 executes processing in accordance with programs and data stored in the storage unit 12. The storage unit 12 includes a main memory unit and an auxiliary memory unit. For example, the main memory unit is a volatile memory, for example, a RAM, and the auxiliary memory unit is a non-volatile memory such as a ROM, an EEPROM, a flash memory, or a hard disk drive.

The communication unit 13 is a communication interface for wired communication or wireless communication, and performs data communication via the network. The communication interface for wireless communication may be an interface for a wireless LAN, maybe an interface capable of communicating to/from a base station of a cell phone, or may be an interface capable of performing short-range wireless communication. Individual identification information on the communication interface or individual identification information on the shop terminal 10 may be stored in the storage unit 12.

The operating unit 14 is an input device to be used by the user for operation, and is, for example, a pointing device such as a touch panel and a mouse, a keyboard, or a button. The operating unit 14 transmits details of operation by the user to the control unit 11. The display unit 15 is, for example, a liquid crystal display unit or an organic EL display unit. The display unit 15 displays a screen in accordance with an instruction of the control unit 11. The GPS sensor 16 includes a receiver configured to receive signals from satellites, and detects latitude/longitude information, which is an absolute position on the earth.

The customer terminal 20 is a portable computer to be operated by a customer, and is, for example, a cell phone (including a smartphone), a mobile information terminal (including a tablet computer), or a laptop personal computer. The term “portable” means that the computer can be carried around, and refers to, for example, a terminal having a size that can be grasped. The customer terminal 20 has a battery incorporated therein, and can operate even when the customer terminal 20 is not connected to a power cable.

The customer terminal 20 includes a control unit 21, a storage unit 22, a communication unit 23, an operating unit 24, a display unit 25, and a GPS sensor 26. Physical configurations of those components may be similar to those of the control unit 11, the storage unit 12, the communication unit 13, the operating unit 14, the display unit 15, and the GPS sensor 16. Further, the customer terminal 20 may include a camera 27. The camera 27 includes, for example, a CCD image sensor or a CMOS image sensor, and photographs a still image or a moving image.

The payment server 30 is a server computer. The payment server 30 includes a control unit 31, a storage unit 32, and a communication unit 33. Physical configurations of the control unit 31, the storage unit 32, and the communication unit 33 may be the same as those of the control unit 11, the storage unit 12, and the communication unit 13, respectively. Programs and data to be described as being stored into the storage units 12, 22, and 32 maybe supplied thereto via a network.

Further, the respective hardware configurations of the computers are not limited to the above-mentioned examples, and various types of hardware can be applied thereto. For example, the hardware configuration may include a reading unit (e.g., an optical disc drive or a memory card slot) configured to read a computer-readable information storage medium, or an input/output unit (e.g., a USB port) configured to input and output data to/from an external device. For example, the program and the data stored in the information storage medium may be supplied to each of the computers through intermediation of the reading unit or the input/output unit.

[1-2. Outline of First Embodiment]

In the first embodiment, a description is given of an exemplary case in which the customer uses the customer terminal 20 to select a recipient shop and input a payment amount, to thereby settle the payment. This payment method is hereinafter referred to as “self-payment”. When the customer uses the self-payment for payment, the customer activates a dedicated application in the customer terminal 20.

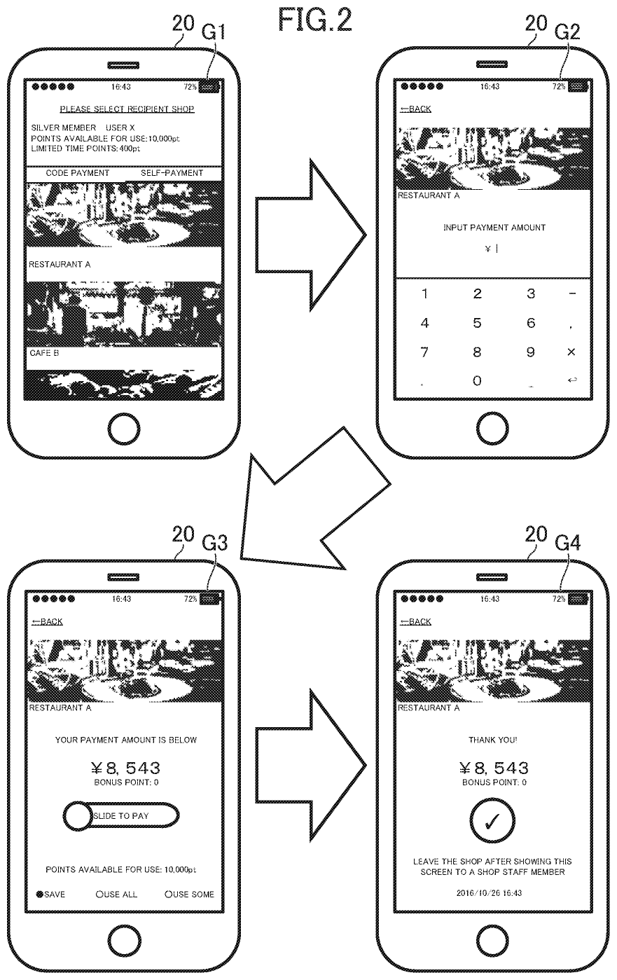

FIG. 2 is a diagram for illustrating transition of a screen after the application is activated. As illustrated in FIG. 2, when the application is activated, a recipient selection screen G1 for selecting a recipient shop is displayed on the display unit 25. For example, shops supporting self-payment are registered in advance in the payment server 30, and the recipient selection screen G1 may display a list of those shops.

The recipient selection screen G1 is displayed in such a manner that a plurality of shops can be scrolled on the recipient selection screen Gl. For example, all the shops registered in the payment server 30 may be displayed, or only a part of shops may be displayed. When only a part of shops may be displayed, only the shops near the customer terminal 20 may be displayed. In this case, the customer may be prompted to input an address of a current location, or the latitude/longitude information detected by the GPS sensor 26 may be used to identify a nearby shop.

When the customer selects a recipient shop on the recipient selection screen G1, the recipient selection screen G1 transitions to an amount input screen G2 for inputting a payment amount. There may be no particular limitation on the amount that can be input via the amount input screen G2, or at least one of the lower limit value or the upper limit value of the amount may be provided. The customer operates the operating unit 24 to input a payment amount.

When the customer inputs a payment amount on the amount input screen G2, the amount input screen G2 transitions to a confirmation screen G3 for confirming payment details. When the user performs a predetermined payment start operation on the confirmation screen G3, a predetermined payment request is transmitted from the customer terminal 20 to the payment server 30. The payment start operation is only required to be a predetermined operation, and for example, may be an operation of sliding an image displayed on the confirmation screen G3 while touching the image.

When the payment server 30 in the first embodiment receives a payment request, the payment server 30 acquires a distance between the latitude/longitude information on the shop terminal 10 and the latitude/longitude information on the customer terminal 20, and allows payment when the distance is small or prohibits payment when the distance is large. When the payment server 30 finishes payment processing, the confirmation screen G3 transitions to a payment completion screen G4 for notifying the fact that payment is complete. The customer shows the payment completion screen G4 to a clerk when the customer leaves the shop, for example. With this, the clerk can confirm the fact that payment by the customer is complete. Notification similar to that of the payment completion screen G4 may be displayed on the shop terminal 10, and in this case, the clerk can confirm the fact that payment by the customer is complete via the notification displayed on the shop terminal 10.

As described above, in principle, all the operations for payment are performed on the customer side in self-payment. Further, the payment system S determines whether or not payment is allowed by using the distance between the latitude/longitude information on the shop terminal 10 and the latitude/longitude information on the customer terminal 20, to thereby eliminate the necessity to manage complicated information as in the related art, simplify the configuration for providing payment with a high degree of freedom in or near the shop, and prevent payment to a shop selected by an erroneous operation by the customer. Now, details of this technology are described.

[1-3. Functions To be Implemented in First Embodiment]

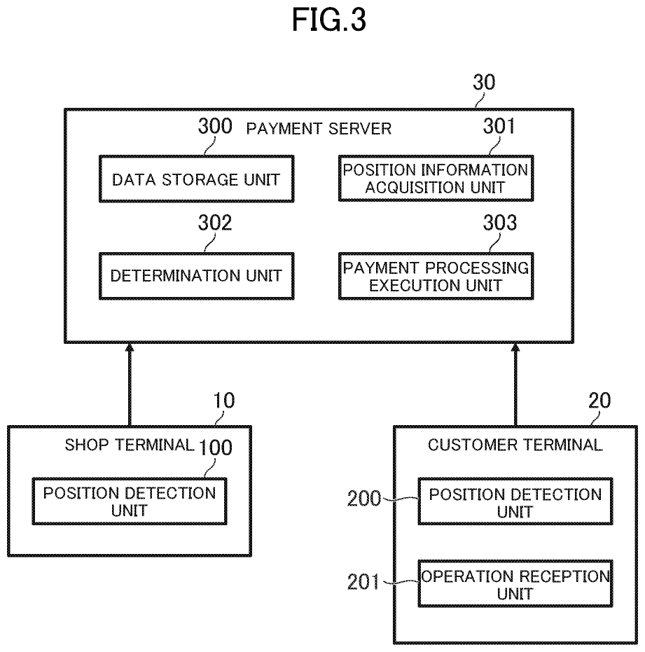

FIG. 3 is a functional block diagram for illustrating an example of functions to be implemented by the payment system S in the first embodiment.

[1-3-1. Functions to be Implemented in Shop Terminal]

A position detection unit 100 is implemented by the shop terminal 10. The position detection unit 100 in the first embodiment is mainly implemented by the GPS sensor 16. The position detection unit 100 detects shop terminal position information indicating the position of the shop terminal 10. For example, the position detection unit 100 detects the shop terminal position information based on signals received from satellites, or a result of communication to/from an external terminal. The shop terminal position information is only required to be information enabling identification of a position on the earth, and may be, for example, the latitude/longitude information or information on a base station for wireless communication. The base station for wireless communication may be, for example, an access point for a wireless LAN, or may be a communication base station of a cell phone. The shop terminal position information is not limited to a detailed position, for example, the latitude/longitude information, and may be such an approximate position as to enable identification of existence within a certain area.

[1-3-2. Functions to be Implemented By Customer Terminal]

A position detection unit 200 and an operation reception unit 201 are implemented by the customer terminal 20. The position detection unit 200 is mainly implemented by the GPS sensor 26, and the operation reception unit 201 is mainly implemented by the control unit 21 and the operating unit 24.

[Position Detection Unit]

The position detection unit 200 detects customer terminal position information indicating the position of the customer terminal 20. For example, the position detection unit 200 detects the customer terminal position information based on signals received from satellites, or a result of communication to/from an external terminal. The customer terminal position information is only required to be information enabling identification of a position on the earth, and may be, for example, the latitude/longitude information or information on abase station for wireless communication. The base station for wireless communication may be, for example, an access point for a wireless LAN, or maybe a communication base station of a cell phone. The customer terminal position information is not limited to a detailed position, for example, the latitude/longitude information, and may be such an approximate position as to enable identification of existence within a certain area.

[Operation Reception Unit]

The operation reception unit 201 receives various kinds of operations performed by the customer. For example, the operation reception unit 201 receives an operation for activating an application or a payment operation performed by the customer. The payment operation is only required to be a predetermined operation for instructing start of payment, and may be finished by one operation or include a plurality of operations. In the case of self-payment, the payment operation includes three steps, namely, an operation for selecting a recipient shop, an operation for inputting a payment amount, and an operation for instructing start of payment.

[1-3-3. Functions to be implemented in Payment Server]

A data storage unit 300, a position information acquisition unit 301, a determination unit 302, and a payment processing execution unit 303 are implemented by the payment server 30. The data storage unit 300 is mainly implemented by the storage unit 32, and the position information acquisition unit 301, the determination unit 302, and the payment processing execution unit 303 are mainly implemented by the control unit 31.

[Data Storage Unit]

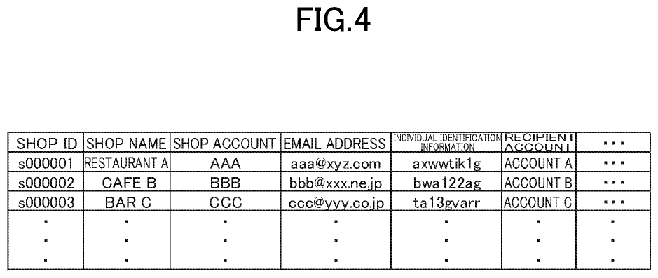

The data storage unit 300 stores data required for payment, and stores a shop database and a customer database, for example. FIG. 4 is a table for showing an example of the shop database. As shown in FIG. 4, the shop database stores various kinds of information relating to a shop. For example, the shop database stores, for example, a shop name, a shop account, an email address, individual identification information (product number or serial number) on the shop terminal 10, and a recipient account for payment, in association with a shop ID for uniquely identifying a shop. Information to be stored in the shop database is not limited to the above-mentioned example, and other information on a shop may be stored. For example, a password required for login, an address, a phone number, a shop image, and other information may be stored in the shop database.

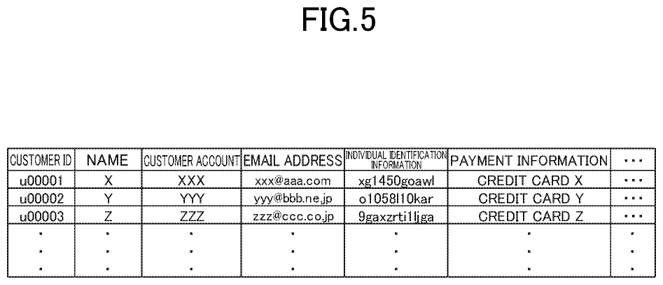

FIG. 5 is a table for showing an example of the customer database. As shown in FIG. 5, the customer database stores various kinds of information relating to a customer. For example, the customer database may, for example, store a customer name, a customer account, an email address, individual identification information (product number or serial number) on the customer terminal 20, and payment information in association with a customer ID for uniquely identifying the customer. The payment information is information required for payment, and is, for example, a credit card number, a debit card number, or a debit account number. Information to be stored in the customer database is not limited to the above-mentioned example, and other information on a customer may be stored. For example, a password required for login and other information may be stored in the customer database.

Data to be stored in the data storage unit 300 is not limited to the above-mentioned example. For example, the data storage unit 300 may store image data for displaying the screen of FIG. 2. Further, for example, the data storage unit 300 may store data for estimating the position by a wireless base station. In this case, the data storage unit 300 may store data indicating association between the identification information on a wireless LAN access point and the position information (e.g., latitude/longitude information and address), or store data indicating association between the identification information on the cell phone base station and the position information (e.g., latitude/longitude information and address).

[Position Information Acquisition Unit]

The position information acquisition unit 301 acquires the shop terminal position information indicating the position of the shop terminal 10 and the customer terminal position information indicating the position of the portable customer terminal 20 on which the customer performs a payment operation. The position information acquisition unit 301 acquires via the network the shop terminal position information detected by the position detection unit 100 of the shop terminal 10 and the customer terminal position information detected by the position detection unit 200 of the customer terminal 20.

In the first embodiment, the GPS sensors 16 and 26 are used, and thus the position information acquisition unit 301 acquires the position information detected by the GPS sensor 16 of the shop terminal 10 as the shop terminal position information, and acquires the position information detected by the GPS sensor 26 of the customer terminal 20 as the customer terminal position information. The position information acquisition unit 301 may acquire the shop terminal position information and the customer terminal position information in real time at the time of payment, but may acquire the shop terminal position information in advance for registration into the shop database. Similarly, the position information acquisition unit 301 may acquire the customer terminal position information in advance for registration into the customer database within a predetermined period (period in which long distance movement cannot be performed, for example, 5 minutes) of payment processing. Those pieces of registered shop terminal position information and customer terminal position information may be periodically updated to the latest information.

In the first embodiment, the payment operation includes an operation of selecting a recipient shop from a plurality of shops, and thus the position information acquisition unit 301 acquires the shop terminal position information on the shop selected by the payment operation. That is, the position information acquisition unit 301 identifies the shop selected by the customer from all the shops registered in advance, and acquires the shop terminal position information on the shop. The position information acquisition unit 301 identifies the shop selected by the payment operation received by the operation reception unit 201.

[Determination Unit]

When the customer terminal 20 performs a payment operation, the determination unit 302 determines whether or not the distance between the position of the shop terminal 10 indicated by the shop terminal position information and the position of the customer terminal 20 indicated by the customer terminal position information is smaller than a threshold value. The threshold value maybe a fixed value or a variable value. When the threshold value is a variable value, for example, the threshold value may be different depending on the shop, customer, or payment details, for example. When the threshold value differs depending on payment details, the threshold value may differ based on the amount. It is assumed that the threshold value is stored in the data storage unit 300 in advance. Further, the threshold value maybe represented in any unit such as meter, kilometer, or mile.

The determination unit 302 acquires the distance for determination based on the shop terminal position information and the customer terminal position information. The distance is not required to indicate an accurate interval between the position of the shop terminal 10 and the position of the customer terminal 20, but may indicate an approximate interval. For example, as in the first embodiment, the position accuracy is high when the latitude/longitude information is used, and thus the accuracy of the distance acquired by the determination unit 302 is high. However, when wireless base station information is used, only the approximate position is estimated. Thus, the accuracy of the distance acquired by the determination unit 302 is not so high, and the distance indicates an approximate interval.

In the first embodiment, the shop is selected by a payment operation, and thus the determination unit 302 determines whether or not the distance between the position of the shop terminal 10 of the shop selected by a payment operation and the position of the customer terminal 20 is smaller than the threshold value. That is, the determination unit 302 identifies the shop selected by the customer from among all the shops registered in advance, and determines whether or not the distance between the position of the shop and the customer terminal 20 is smaller than the threshold value. The determination unit 302 identifies the shop selected by the payment operation received by the operation reception unit 201.

[Payment Processing Execution Unit]

The payment processing execution unit 303 can execute payment processing based on the result of determination by the determination unit 302. The payment processing execution unit 303 executes or does not execute payment processing depending on the result of determination by the determination unit 302. The payment processing is software processing for payment to a shop. Known processing can be employed as the payment processing, and for example, the payment processing may be credit card payment processing or bank account debit processing. When the payment processing is credit card payment processing, the payment processing is executed through transmission of a credit inquiry to a server of a credit card company. When the payment processing is debit processing, the payment processing is executed through transmission of a debit request to a server of a bank for which the customer holds an account.

In the first embodiment, when the determination unit 302 determines that the distance is smaller than the threshold value, the payment processing execution unit 303 allows execution of the payment processing, whereas when the determination unit 302 determines that the distance is equal to or larger than the threshold value, the payment processing execution unit 303 prohibits execution of the payment processing. In other words, the payment processing execution unit 303 executes the payment processing when the determination unit 302 determines that the distance is smaller than the threshold value, and the payment processing execution unit 303 does not execute the payment processing when the determination unit 302 determines that the distance is equal to or larger than the threshold value. In the first embodiment, when the determination unit 302 determines that the distance is equal to or larger than the threshold value, the payment processing execution unit 303 does not execute the payment processing automatically without particularly holding the payment processing or making an inquiry to the shop or the customer.

[1-4. Processing to be Executed in First Embodiment]

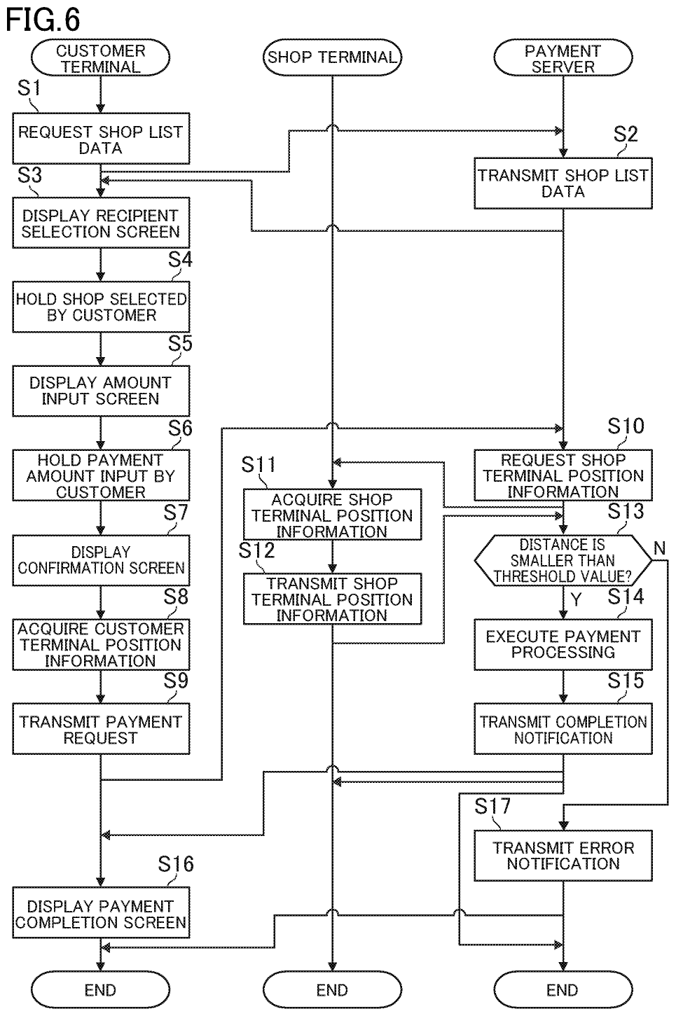

FIG. 6 is a flow chart for illustrating an example of processing to be executed by the payment system. The processing illustrated in FIG. 6 is executed by the control units 11, 21, and 31 operating in accordance with programs stored in the storage units 12, 22, and 32, respectively. The processing described below is an example of processing to be executed by the functional blocks illustrated in FIG. 3.

As illustrated in FIG. 6, first, the customer terminal 20 activates an application stored in the storage unit 22, and requests the payment server 30 for shop list data indicating a list of shops (Step S1). When the customer terminal 20 communicates to/from the payment server 30, information (e.g., IP address, customer account, individual identification information, or session ID) for identifying the customer terminal 20 is transmitted, to thereby enable the payment server 30 to identify which customer is accessing. Further, after the application is activated, input of the customer account and the password may be requested for login to the payment server 30.

When the payment server 30 receives the request for shop list data, the control unit 31 transmits shop list data to the customer terminal 20 based on the shop database (Step S2). In Step S2, the control unit 31 may include information on all the shops in the shop list data, or may include only the information on nearby shops in the shop list data. When the control unit 31 includes only the information on nearby shops in the shop list data, the customer terminal position information may be transmitted to the payment server 30 from the customer terminal 20 in Step S1. The shop list data contains information for displaying the recipient selection screen G1, and contains information such as the shop ID, the shop name, and the shop image.

When the customer terminal 20 receives the shop list data, the control unit 21 displays the recipient selection screen G1 on the display unit 25 based on the shop list data (Step S3). When the customer operates the operating unit 24 to select a recipient shop, the control unit 21 holds the shop ID of the selected shop in the storage unit 22 (Step S4), and displays the amount input screen G2 on the display unit 25 (Step S5). Data for displaying the amount input screen G2 may be transmitted from the payment server 30, but in this description, it is assumed that the data is stored in the storage unit 22 together with the application. This point holds true also for the confirmation screen G3.

The control unit 21 holds the amount input through operation of the operating unit 24 by the customer in the storage unit 22 (Step S6), and displays the confirmation screen G3 on the display unit 25 based on the shop selected by the customer and the input payment amount (Step S7). When the customer performs a payment start operation through the operating unit 24, the control unit 21 acquires the customer terminal position information based on a detection signal of the GPS sensor 26 (Step S8). As described above, the customer terminal position information may be acquired in advance before the payment start operation (e.g., at activation of application), and held in the storage unit 22. The control unit 21 transmits, to the payment server 30, a payment request including: the shop ID held in the storage unit 22 and the payment amount; and the customer terminal position information acquired in Step S9 (Step S9).

When the payment server 30 receives a payment request, the control unit 31 requests the shop terminal 10 of the shop indicated by the shop ID included in the payment request for the shop terminal position information based on the shop database (Step S10). In Step S10, the control unit 31 identifies a target shop terminal 10 based on the individual identification information associated with the shop ID included in the payment request, and requests the shop terminal 10 for the shop terminal position information. The request is only required to be issued in a predetermined data format, and it is assumed that the shop terminal 10 is set to provide the shop terminal position information.

When the shop terminal 10 receives the request, the control unit 11 acquires the shop terminal position information based on a detection signal of the GPS sensor 16 (Step S11). The shop terminal position information may be acquired in advance, and held in the storage unit 12. The control unit 11 transmits the shop terminal position information to the payment server 30 (Step S12). Information for identifying the shop terminal 10 (e.g., IP address, shop account, individual identification information, or session ID) is transmitted also when the shop terminal 10 communicates to/from the payment server 30, to thereby enable the payment server 30 to identify which shop is accessing.

When the payment server 30 receives the shop terminal position information, the control unit 31 determines whether or not a distance between the position of the shop terminal 10 indicated by the shop terminal position information and the position of the customer terminal 20 indicated by the customer terminal position information is smaller than the threshold value (Step S13). In Step S13, the control unit 31 calculates an interval between the latitude/longitude information acquired from the shop terminal 10 and the latitude/longitude information acquired from the customer terminal 20, and compares the interval with the threshold value stored in the storage unit 32.

When it is determined that the distance is smaller than the threshold value (Step S13: Y), the control unit 31 executes the payment processing based on the shop database and the customer database (Step S14), and transmits a predetermined completion notification to the shop terminal 10 and the customer terminal 20 (Step S15). In Step S14, the control unit 31 acquires recipient information by referring to the shop database, acquires credit card information on the customer by referring to the customer database, and executes the credit card payment processing of paying the payment amount indicated by the payment request to the shop. It is assumed that the completion notification transmitted in Step S15 contains details of finished payment.

When the customer terminal 20 receives the completion notification, the control unit 21 displays the payment completion screen G4 on the display unit 25 (Step S16). After that, the customer shows the payment completion screen G4 to the clerk, and leaves the shop. The shop terminal 10 has also received a completion notification, and thus the clerk is in a state of capable of confirming the completion notification via the shop terminal 10.

Meanwhile, in Step S14, when it is determined that the distance is equal to or larger than the threshold value (Step S13: N), the control unit 31 does not execute the payment processing, and transmits a predetermined error notification to the customer terminal 20 (Step S17). When the customer terminal 20 receives the error notification, the control unit 21 displays a predetermined error message on the display unit 25. After that, the customer may be able to perform a payment operation again.

With the payment system S described above, the payment processing can be executed based on the distance between the position of the shop terminal 10 indicated by the shop terminal position information and the position of the customer terminal 20 indicated by the customer terminal position information, and thus it is possible to implement payment with a high degree of freedom in or near the shop with simple processing of acquiring the positions of two terminals, to thereby simplify the configuration. For example, the shape and width of the site of the shop are not required to be prepared for each shop, and thus a large amount of information is not required to be managed, and information is easily managed. Further, for example, the position of the shop terminal 10 and the position of the customer terminal 20 are easily acquired information, and thus it is possible to simplify the processing without complicated processing. As a result, it is possible to effectively utilize the resources of the payment system S.

Further, as in the first embodiment, payment is automatically prohibited when the distance between the shop terminal 10 and the customer terminal 20 is equal to or larger than the threshold value, to thereby be able to ensure payment in or near the shop more reliably.

Further, as in the first embodiment, in the case of self-payment, the customer selects a recipient by himself or herself, resulting in a possibility of erroneous selection. However, when the customer selects an erroneous recipient shop, the distance between the shop terminal 10 and the customer terminal 20 becomes equal to or larger than the threshold value, and payment is prohibited. Thus, it is possible to prevent erroneous payment due to an erroneous selection by the customer. For example, even when the customer terminal position information is used to enable selection of only the nearby shops, there may be a plurality of shops having similar names in one region for, for example, a chain shop, with the result that the customer may select an erroneous shop. However, it is possible to prevent an erroneous selection more reliably through determination based on the distance as in the first embodiment. Further, payment of a small amount may be repeated at a distant location for mischief or harassment to the shop, but such payment is also prohibited, and thus it is possible to prevent mischief or harassment.

Further, more accurate information can be acquired by using the GPS to acquire the shop terminal position information and the customer terminal position information, and thus it is possible to improve the reliability of implementing payment with a high degree of freedom in or near the shop.

### 2. Second Embodiment

In the first embodiment, self-payment, in which the customer inputs the recipient shop and the payment amount by himself or herself, is given as an example, but payment to the shop may be performed by the customer terminal 20 reading code information displayed on the display unit 15 of the shop terminal 10 without the customer inputting those pieces of information. In the following, this payment method is described as “code payment”.

[2-1. Outline of Second Embodiment]

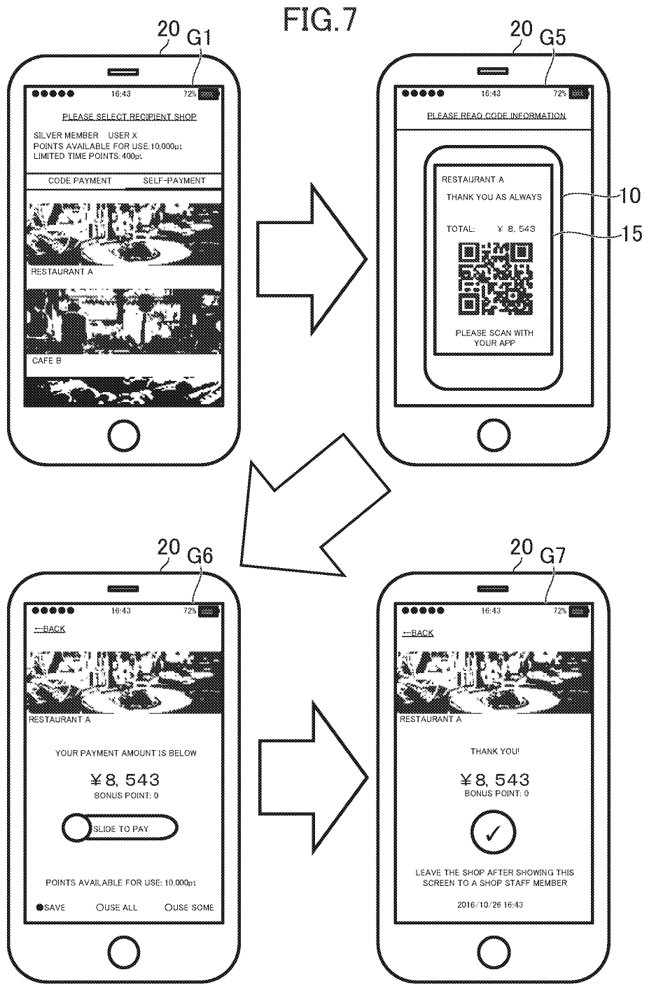

FIG. 7 is a diagram for illustrating transition of a screen in payment by code payment. For example, when the clerk inputs the payment amount into the shop terminal 10, code information containing the shop ID and the payment amount is displayed on the display unit 15. As illustrated in FIG. 7, when the customer activates an application on the customer terminal 20 to select a “code payment” tab of the recipient selection screen G1, the camera 27 is activated.

When the camera 27 is activated, the screen transitions to a photographing screen G5 representing an image photographed by the camera 27. The customer adjusts and fixes the posture of the customer terminal 20 so that the photographing range of the camera 27 contains code information displayed on the display unit 15. When the code information has successfully been read, the shop ID and the payment amount contained in the code information are extracted, and the screen transitions to a confirmation screen G6. The confirmation screen G6 is similar to the confirmation screen G3 (FIG. 2) of self-payment, and the subsequent flow is also the same as that of self-payment. In a case where the user performs a payment start operation via the confirmation screen G6, payment processing is executed when the distance between the position of the shop terminal 10 and the position of the customer terminal 20 is small, and the screen transitions to a completion screen G7.

With the code payment described above, for example, a malicious customer may photograph the code information with the customer terminal 20, transmit the code information to a cooperator operating a dedicated terminal for illegally accessing, for example, the server of the credit card company, settle the illegal payment, receive only the display data of the payment completion screen, and show the payment completion screen to the clerk to pretend to have completed valid payment. For example, in order to prevent such an illegal behavior with a simple configuration, the payment system S according to a second embodiment of the present invention is configured to control whether to allow or prohibit payment based on the distance between the position of the shop terminal 10 and the position of the customer terminal 20 in code payment. Now, a detailed description is given of details of the processing in the second embodiment, but description of components similar to those of the first embodiment, for example, the hardware configuration of the payment system S, is omitted.

[2-2. Functions to be Implemented in Second Embodiment]

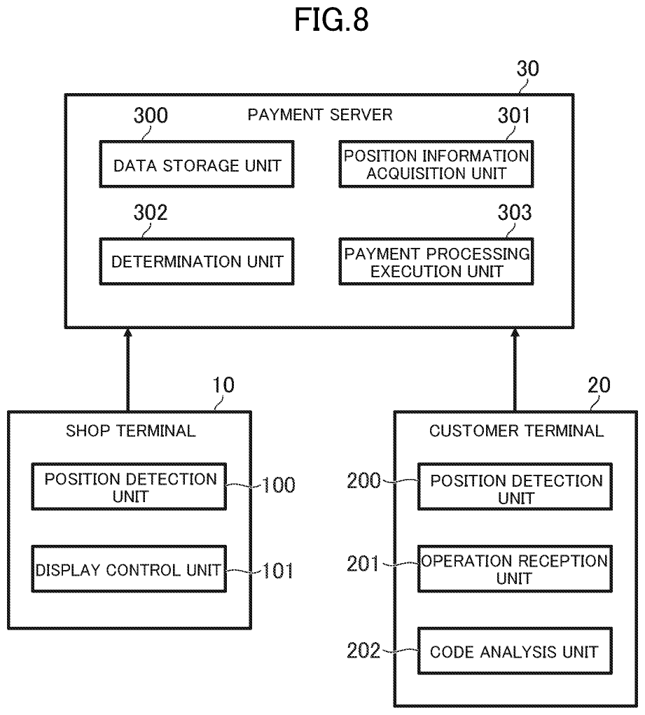

FIG. 8 is a functional block diagram in the second embodiment. As illustrated in FIG. 8, in the second embodiment, a display control unit 101 is implemented in the shop terminal 10 and a code analysis unit 202 is implemented in the customer terminal 20 in addition to the functions described in the first embodiment. The functional blocks of the payment server 30 are similar to those of the first embodiment (FIG. 3), but the details of processing are different from those of the first embodiment.

The display control unit 101 of the shop terminal 10 is mainly implemented by the control unit 11. The display control unit 101 displays the code information for identifying the shop on the display unit 15. The code information is only required to indicate an image enabling image analysis, and may be, for example, a barcode or a two-dimensional code. A code generation algorithm for coding the input information is stored in the storage unit 12 of the shop terminal 10, and the display control unit 101 passes the shop ID and the payment amount to the code generation algorithm, to thereby generate the code information. Various kinds of publicly known algorithms can be employed as the code generation algorithm itself.

The code analysis unit 202 of the customer terminal 20 is mainly implemented by the control unit 21. The code analysis unit 202 analyzes an image obtained by photographing the code information displayed on the display unit 15, and extracts the shop ID and the payment amount contained in the code information.

The code generation algorithm for extracting information from a code is stored in the storage unit 22 of the customer terminal 20, and the code analysis unit 202 passes the code information photographed by the camera 27 to the code analysis algorithm, to thereby identify details contained in the code information. Various kinds of publicly known algorithms can be employed as the code analysis algorithm itself.

In the second embodiment, the payment operation includes an operation for causing the camera of the customer terminal 20 to read the code information displayed on the display unit 15. Thus, the payment operation may include an operation for activating the camera 27 to photograph an image and an operation for changing the posture of the customer terminal 20 so that the code information displayed on the display unit 15 is contained within the photographing range of the camera 27.

Further, in the second embodiment, the recipient shop is identified by the code information, and thus the position information acquisition unit 301 of the payment server 30 acquires the shop terminal position information on the shop indicated by the code information read through a payment operation. The position information acquisition unit 301 acquires the shop terminal position information on the shop identified by the code analysis unit 202.

The determination unit 302 determines whether or not the distance between the position of the shop terminal 10 of the shop indicated by the code information read through a payment operation and the position of the customer terminal 20 is smaller than the threshold value. The determination unit 302 executes determination processing based on the shop terminal position information on the shop identified by the code analysis unit 202. Further, the payment processing execution unit 303 can execute payment processing for the shop indicated by the code information read through a payment operation. The determination method performed by the determination unit 302 and the payment processing are similar to those of the first embodiment.

[2-3. Processing to be Executed in Second Embodiment]

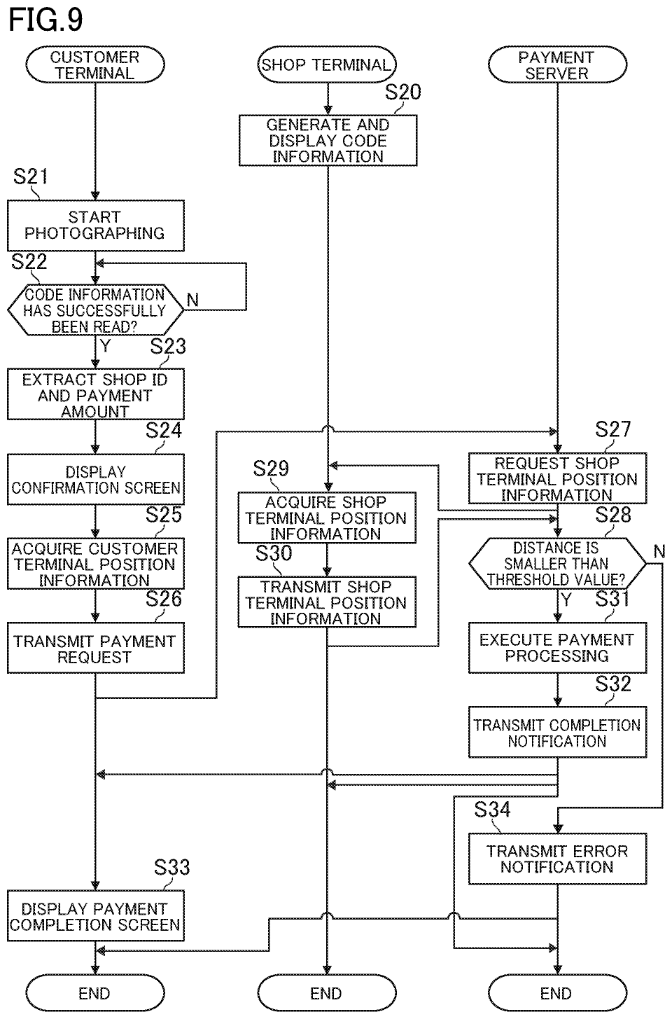

FIG. 9 is a flow chart for illustrating an example of processing to be executed in the second embodiment. The processing illustrated in FIG. 9 is executed by the control units 11, 21, and 31 operating in accordance with programs stored in the storage units 12, 22, and 32, respectively. Of processes described below, processes of the payment server 30 are examples of processes to be executed by the functional blocks illustrated in FIG. 8.

As illustrated in FIG. 9, first, the control unit 11 of the shop terminal 10 generates the code information for display on the display unit 15 based on the shop ID and the payment amount input through an operation of the operating unit 14 by the clerk (Step S20). The shop ID may be stored in the storage unit 12 in advance, or may be input through the operating unit 14. In Step S20, the control unit 11 passes the shop ID and the payment amount to the code generation algorithm, and code information returned by the code generation algorithm is displayed on the display unit 15.

The control unit 21 of the customer terminal 20 activates an application, and starts photographing by the camera 27 (Step S21). After the application is activated, processing similar to that of Step S1 to Step S3 maybe executed to display the recipient selection screen G1. In this case, the tab for code payment of the recipient selection screen G1 may be selected to execute the processing of Step S21.

The control unit 21 analyzes the image photographed by the camera 27 based on the code analysis algorithm to determine whether or not the code information has success fully been read (Step S22).

For example, regarding the two-dimensional code, the control unit 21 may determine whether or not a finder pattern near the end of the code has been detected. When it is determined that the code information has successfully been read (Step S22: Y), the control unit 21 extracts the shop ID and payment amount contained in the code information (Step S23). In Step S23, the control unit 21 passes the code information photographed by the camera 27 to the code analysis algorithm, and acquires the shop ID and payment amount returned by the code analysis algorithm. The subsequent processing of Step S24 to Step S34 is similar to that of Step S7 to Step S17.

With the payment system S of the second embodiment, when payment is performed by code payment, it is possible to simplify the configuration for implementing payment with the high degree of freedom in or near the shop. Further, in code payment, as described above, a malicious customer may illegally transmit the code information to a cooperator, but such an illegal behavior can also be prevented.

### [3. Modification Examples]

The present invention is not limited to the embodiments described above, and can be modified suitably without departing from the spirit of the present invention.

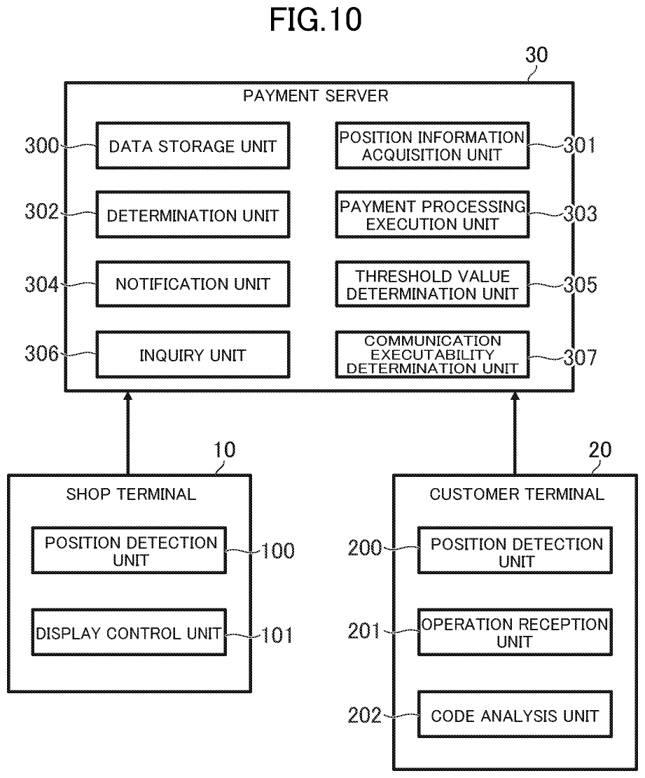

FIG. 10 is a functional block diagram in modification examples of the present invention. As illustrated in FIG. 10, in the modification examples described later, a notification unit 304, a threshold value determination unit 305, an inquiry unit 306, and a communication executability determination unit 307 are implemented in addition to the functions described in the first and second embodiments.

(1) For example, in the first and second embodiments, payment processing is automatically prohibited when the distance between the position of the shop terminal 10 and the position of the customer terminal 20 is equal to or larger than the threshold value, but payment processing may temporarily be held and an inquiry as to whether or not to execute payment may be issued to at least one of the clerk or the customer. Then, the held payment processing may be executed based on an answer given by at least one of the clerk or the customer.

The payment processing execution unit 303 in this modification example allows execution of the payment processing when the distance is determined to be smaller than the threshold value by the determination unit 302, whereas the e payment processing execution unit 303 holds (stops) execution of the payment processing when the distance is determined to be equal to or larger than the threshold value by the determination unit 302. For example, a list of held payments may be stored in the data storage unit 300, and the payment processing execution unit 303 may add details of the held payment to the list.

The payment system S in this modification example includes the notification unit 304. The notification unit 304 is mainly implemented by the control unit 31. When execution of the payment processing is held by the payment processing execution unit 303, the notification unit 304 issues a predetermined notification to at least one of the shop terminal 10 or the customer terminal 20. The notification may be issued to both of the shop terminal 10 and the customer terminal 20, or may be issued to any of the shop terminal 10 or the customer terminal 20. Now, a description is given of a case of issuing a notification to the shop terminal 10.

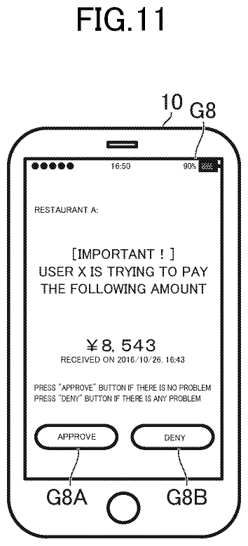

FIG. 11 is a diagram for illustrating an example of a notification issued by the notification unit 304. As illustrated in FIG. 11, a notification G8 indicating details of the held payment is displayed on the display unit 15 of the shop terminal 10. Image data for notification may be transmitted to the shop terminal 10 from the notification unit 304. For example, the notification G8 may contain information such as the customer who has originally given an instruction to settle the held payment, the recipient shop, and the payment amount, together with a warning message indicating the fact that payment is held. Further, the notification G8 displays an “approve” button G8A for approving payment and a “deny” button G8B for denying payment. When the clerk determines that there is no problem with the held payment, the clerk selects the “approve” button G8A, whereas when the clerk does not remember the payment and determines the payment to be illegal, the clerk selects the “deny” button G8B.

At least one terminal (shop terminal 10 in this case), which has been given a notification by the notification unit 304, receives an operation for approving or denying the held payment processing. The description is based on the case of the terminal being the shop terminal 10, and thus the shop terminal 10 determines whether the “approve” button G8A or the “deny” button G8B is selected based on the detection signal from the operating unit 24. The approval operation and denial operation are not limited to an operation of selecting a button, and are only required to be a predetermined operation. Then, the shop terminal 10 transmits information for identifying the selected one of the “approve” button G8A and the “deny” button G8B to the payment server 30.

When the payment processing execution unit 303 receives an approval operation, the payment processing execution unit 303 allows execution of the held payment processing, whereas when the payment processing execution unit 303 receives a denial operation, the payment processing execution unit 303 prohibits execution of the held payment processing. The payment processing execution unit 303 determines which one of the “approve” button G8A and the “deny” button G8B is selected based on the information received from the shop terminal 10. When an approval operation is received, the payment processing execution unit 303 executes payment processing similar to that executed in the case in which the distance is smaller than the threshold value in the first and second embodiments. On the contrary, when the payment processing execution unit receives a denial operation, the payment processing execution unit does not execute payment processing similarly to the case in which the distance is equal to or larger than the threshold value in the first and second embodiments, and for example, deletes data representing details of the held payment from the list in the data storage unit 300. The payment processing execution unit 303 may prohibit execution of the held payment processing when an approval operation has not been received for a fixed period of time.

According to Modification Example (1) of the present invention, the held payment processing can be executed based on an operation performed by at least one of the clerk or the customer. For example, when a notification is displayed on the customer terminal 20 in self-payment, it is possible to notice through notification the fact that the customer has selected an erroneous recipient shop. Further, for example, when a notification is displayed on the shop terminal 10, whether or not to execute payment can be entrusted to the shop, and thus it is possible to prevent such a trouble that a valid customer cannot also settle the payment due to, for example, a communication failure.

(2) Further, for example, the signal intensity of the GPS may be weak and the accuracy of the latitude/longitude information may be low depending on the shop. Thus, when a common threshold value is used among all the shops, a shop having a weak signal intensity of the GPS causes the distance between the shop terminal 10 and the customer terminal 20 to exceed the threshold value although the customer is inside the shop, resulting in a possibility that self-payment or code payment cannot be executed. Thus, the threshold value of the distance may be changed depending on the signal intensity of the GPS.

The payment system according to Modification Example (2) of the present invention includes the threshold value determination unit 305. The threshold value determination unit 305 is mainly implemented by the control unit 31. The threshold value determination unit 305 determines the threshold value based on the intensity of the signal received by the GPS sensor 16 of the shop terminal 10 and the intensity of the signal received by the GPS sensor 26 of the customer terminal 20. The signal intensity of the GPS can be measured by one of publicly known measurement methods. For example, a signal component and a noise component may be extracted from a result of reception by the receiver based on predetermined noise filtering, and an S/N ratio may be calculated to calculate the signal intensity of the GPS.

For example, the position detection unit 100 of the shop terminal 10 can acquire the intensity of the signal of the GPS sensor 16, and the position information acquisition unit 301 acquires the intensity of the signal together with the shop terminal position information. Further, for example, the position detection unit 200 of the customer terminal 20 can acquire the intensity of the signal of the GPS sensor 26, and the position information acquisition unit 301 acquires the intensity of the signal together with the customer terminal position information. The threshold value determination unit 305 determines the threshold value based on the intensity of the signal acquired by the position information acquisition unit 301.

For example, information indicating the relationship between the intensity of the signal and the threshold value may be stored in the data storage unit 300. This relationship may be represented by a mathematical expression or a table, or described as a part of a programming code. The threshold value determination unit 305 decreases the threshold value as the intensity of the signal received by the GPS sensor of the shop terminal 10 and the intensity of the signal received by the GPS sensor of the customer terminal 20 become stronger, and increases the threshold value as those intensities become weaker. When the threshold value is increased excessively, payment at a location far from the shop is allowed, and thus an upper limit value of the threshold value may be set.

With Modification Example (2), it is possible to prevent such a situation that the customer cannot settle the payment when the communication environment is poor by setting the threshold value depending on the signal intensity of the GPS, and it is thus possible to provide a service that suits the usage environment of the system.

(3) Further, for example, in the first and second embodiments, the description is based on the assumption that the GPS is used to acquire the shop terminal position information and the customer terminal position information. However, as described above, the position of the terminal may be acquired by using the method other than the GPS. When the wireless LAN access point information and the cell phone base station information are used, the accuracy of the position is not higher than that of the GPS, and thus the threshold value for the distance may be changed depending on the position detection method.

Each of the shop terminal 10 and the customer terminal 20 includes at least one type of the position detection units 100 and 200. The position detection units 100 and 200 in this modification example may be implemented by wireless communication interfaces of the communication units 13 and 23, respectively, other than the GPS. When a plurality of types of detection methods can be used, the shop or customer can set which detection method is to be used.

The threshold value determination unit 305 in Modification Example (3) of the present invention determines the threshold value based on the type (position detection method) of the position detection unit 100 of the shop terminal 10 having detected the shop terminal position information and the type (position detection method) of the position detection unit 200 of the customer terminal 20 having detected the customer terminal position information. The threshold value determination unit 305 can acquire information for identifying the types of the position detection units 100 and 200. For example, the type of the position detection unit 100 maybe stored in the storage unit 12 of the shop terminal 10, and the type of the position detection unit 200 may be stored in the storage unit 22 of the customer terminal 20.

For example, the position detection unit 100 of the shop terminal 10 acquires information indicating the type of the position detection unit used for detecting the shop terminal position information, and the position information acquisition unit 301 acquires information indicating the type together with the shop terminal position information. Further, for example, the position detection unit 200 of the customer terminal 20 acquires information indicating the type of the position detection unit used for detecting the customer terminal position information, and the position information acquisition unit 301 acquires information indicating the type together with the customer terminal position information. The threshold value determination unit 305 determines the threshold value based on the types of the position detection units 100 and 200 acquired by the position information acquisition unit 301.

For example, information indicating the relationship between the types of the position detection units 100 and 200 and the threshold value may be stored in the data storage unit 300. This relationship may be represented by a mathematical expression or a table, or described as a part of a programming code. For example, the accuracies of positions are high when the position detection unit 100 of the shop terminal 10 is a GPS sensor and the position detection unit 200 of the customer terminal 20 is a GPS sensor, and thus the threshold value determination unit 305 sets the threshold value to a first threshold value, which is the smallest. Further, for example, the accuracies of positions are intermediate when the position detection unit 100 of the shop terminal 10 has a wireless LAN interface and the position detection unit 200 of the customer terminal 20 has a wireless LAN interface, and thus the threshold value determination unit 305 sets the threshold value to a second threshold value, which is larger than the first threshold value. Further, for example, the accuracies of positions are low when the position detection unit 100 of the shop terminal 10 has a cell phone interface and the position detection unit 200 of the customer terminal 20 has a cell phone interface, and thus the threshold value determination unit 305 sets the threshold value to a third threshold value, which is larger than the second threshold value. The type of the position detection unit 100 of the shop terminal 10 and the type of the position detection unit 200 of the customer terminal 20 are not required to be the same, and may be different from each other.

According to Modification Example (3) of the present invention, the threshold value is set depending on the accuracies of the position detection units 100 and 200, to thereby be able to prevent such a situation that the customer cannot settle the payment due to the communication environment and the terminal performance, and it is thus possible to provide a service that suits the usage environment of the system.

(4) Further, for example, at least one of the shop terminal position information or the customer terminal position information cannot be acquired at all in some cases depending on the usage environments of the shop terminal 10 and the customer terminal 20. In this case, the customer cannot settle the payment, and thus the shop or customer may be inquired of whether or not to settle the payment.

For example, the payment processing execution unit 303 holds payment processing when at least one of the shop terminal position information or the customer terminal position information cannot be acquired. The payment processing execution unit 303 determines an acquisition failure when at least one of the shop terminal position information or the customer terminal position information has not been acquired for a fixed period of time. The phrase “fixed period of time” in this case may refer to a fixed period of time elapsed since reception of a payment request from the customer terminal 20, or refer to a fixed period of time elapsed since the shop terminal 10 is requested to provide the shop terminal position information. The method of holding payment processing may be similar to the method described in Modification Example (1).

The payment system. S according to Modification Example (4) of the present invention includes the inquiry unit 306. The inquiry unit 306 is mainly implemented by the control unit 31. The inquiry unit 306 makes an inquiry as to whether or not to execute payment processing to at least one of the shop terminal 10 or the customer terminal 20 when at least one of the shop terminal position information or the customer terminal position information cannot be acquired. The inquiry may be made to both of the shop terminal 10 and the customer terminal 20, or to any one of the shop terminal 10 and the customer terminal 20. This description is based on the assumption that the inquiry is made to the shop terminal 10.

The inquiry may be made on a screen similar to that of FIG. 11, and the inquiry representing details of the held payment is displayed on the display unit 15 of the shop terminal 10. For example, the inquiry may contain information on the customer who has originally given an instruction to settle the held payment, the payment amount, and the like. The display unit 15 may display an “approve” button for approving payment and a “deny” button for denying payment.

The at least one terminal (shop terminal 10 in this case), which has been given an inquiry by the inquiry unit 306, receives an operation for approving or denying the payment processing. The description is based on the case of the terminal being the shop terminal 10, and thus the shop terminal 10 determines whether the “approve” button or the “deny” button is selected based on the detection signal from the operating unit 24. Modification Example (4) is similar to Modification Example (1) in that the approval operation and the denial operation are not limited to selection of a button.

When the payment processing execution unit 303 receives an approval operation, the payment processing execution unit 303 allows execution of the payment processing, whereas when the payment processing execution unit 303 receives a denial operation, the payment processing execution unit 303 prohibits execution of the payment processing. When an approval operation is received, the payment processing execution unit 303 executes payment processing similar to that executed in the case in which the distance is smaller than the threshold value in the first and second embodiments. On the contrary, when the payment processing execution unit receives a denial operation, the payment processing execution unit does not execute payment processing similarly to the case in which the distance is equal to or larger than the threshold value in the first and second embodiments, and for example, deletes data representing details of the held payment from the data storage unit 300.

According to Modification Example (4), the customer can settle the payment even at a location where the communication environment is poor, for example, a location where GPS signals cannot be received.

(5) Further, for example, when at least one of the shop terminal position information or the customer terminal position information cannot be acquired at all, whether or not the shop terminal 10 and the customer terminal 20 are close to each other may be examined not by an inquiry as in Modification Example (4) but by short-range wireless communication. That is, when at least one of the shop terminal position information or the customer terminal position information cannot be acquired, the method of examining whether or not the shop terminal 10 and the customer terminal 20 are close to each other may be switched.

For example, the shop terminal 10 and the customer terminal 20 can perform short-range wireless communication. Various kinds of communication as specified in the international standard can be employed as the short-range wireless communication itself. The payment system S according to Modification Example (5) of the present invention includes the communication executability determination unit 307. When at least one of the shop terminal position information or the customer terminal position information cannot be acquired, the communication executability determination unit 307 determines whether or not the shop terminal 10 and the customer terminal 20 can perform short-range wireless communication.

For example, when the shop terminal position information cannot be acquired, the shop terminal 10 notifies the communication executability determination unit 307 of that fact. Further, for example, when the customer terminal position information cannot be acquired, the customer terminal 20 notifies the communication executability determination unit 307 of that fact. The communication executability determination unit 307 may determine that at least one of the shop terminal position information or the customer terminal position information cannot be acquired through reception of those notifications, or determine that at least one of the shop terminal position information or the customer terminal position information cannot be acquired when there has been no response for a fixed period of time.

When at least one of the shop terminal position information or the customer terminal position information cannot be acquired, the communication executability determination unit 307 instructs the shop terminal 10 and the customer terminal 20 to connect to each other by short-range wireless communication. For example, the communication executability determination unit 307 acquires individual identification information on the shop terminal 10 and individual identification information (e.g., MAC address or serial number) on a short-range wireless communication interface of the shop terminal 10, and transmits the information to the customer terminal 20. Further, for example, the communication executability determination unit 307 acquires the individual identification information on the customer terminal 20 and individual identification information (e.g., MAC address or serial number) on a short-range wireless communication interface of the customer terminal 20, and transmits the information to the shop terminal 10. In this manner, the shop terminal 10 and the customer terminal 20 can acquire information for identifying each other, and detect each other by short-range wireless communication. The shop terminal 10 and the customer terminal 20 activate the respective short-range wireless communication interfaces, search for a communication partner by using individual identification information on each other, and transmit notifications to the effect that the short-range wireless communication can be performed to the communication executability determination unit 307 when there is a terminal matching the individual identification information. The notification may be issued by at least one of the shop terminal 10 or the customer terminal 20. When the communication executability determination unit 307 receives the notification to that effect, the communication executability determination unit 307 determines that short-range wireless communication can be performed, whereas when the notification has failed to be received within a fixed period of time, the communication executability determination unit 307 determines that short-range wireless communication cannot be performed.

The payment processing execution unit 303 in this modification example can execute payment processing based on a result of determination by the communication executability determination unit 307 when at least one of the shop terminal position information or the customer terminal position information cannot be acquired. For example, the payment processing execution unit 303 may allow execution of the payment processing when the communication executability determination unit 307 determines that a connection can be made, or prohibit execution of the payment processing when the communication executability determination unit 307 does not determine that a connection can be made. In other cases, the payment processing execution unit 303 may make such an inquiry as in Modification Example (4) when the communication executability determination unit 307 does not determine that a connection can be made.

According to Modification Example (5) of the present invention, closeness between the shop terminal 10 and the customer terminal 20 is verified by short-range wireless communication, and thus it is possible to settle the payment by switching the method of determining that the shop terminal 10 and the customer terminal 20 are close to each other even at the location where the communication environment is poor.

(6) Further, for example, the first and second embodiments maybe combined. The customer or the shop maybe able to specify which of self-payment or code payment is to be used. Further, two or more of the above-mentioned modification examples may be combined.

Further, for example, the payment processing is not limited to credit card payment processing or bank account debit processing, but may be payment that uses an electronic value. In this case, the customer terminal 20 may include an IC chip that records an electronic value. The IC chip includes a control unit, a storage unit, and a communication unit, and the storage unit stores balance information on the electronic value or a program for changing the balance information. Then, the IC chip may change the stored balance information in response to an instruction from the payment server 30 or other servers.

Further, for example, the determination unit 302, the position information acquisition unit 301, and the payment processing execution unit 303 may be implemented not by the payment server 30 but by the shop terminal 10 or the customer terminal 20. In this case, the shop terminal 10 and the customer terminal 20 may transmit/receive information required for processing between the shop terminal 10 and the customer terminal 20 by direct communication (P2P communication) between the shop terminal 10 and the customer terminal 20. For example, when the determination unit 302, the position information acquisition unit 301, and the payment processing execution unit 303 are implemented by the shop terminal 10, those components are mainly implemented by the control unit 11. Further, for example, when the determination unit 302, the position information acquisition unit 301, and the payment processing execution unit 303 are implemented by the customer terminal 20, those components are mainly implemented by the control unit 21.

The invention claimed is:

1. A payment system comprising at least one processor configured to:
acquire shop terminal position information for indicating a position of a shop terminal when a portable customer terminal reads code information for identifying the shop, the code information being displayed in the shop terminal;
acquire customer terminal position information for indicating a position of the portable customer terminal;
determine whether a distance between the position of the shop terminal indicated by the shop terminal position information and the position of the portable customer terminal indicated by the customer terminal position information is smaller than a threshold value: and
execute payment processing for the shop based on a result of the determination.

2. The payment system according to claim 1, wherein the at least one processor allows execution of the payment processing when it is determined that the distance is smaller than the threshold value, and prohibits execution of the payment processing when it is determined that the distance is equal to or larger than the threshold value.

3. The payment system according to claim 1, wherein the at least one processor:
allows execution of the payment processing when it is determined that the distance is smaller than the threshold value, and holds execution of the payment processing when it is determined that the distance is equal to or larger than the threshold value, and
issues a predetermined notification on at least one of the shop terminal or the portable customer terminal when execution of the payment processing,
wherein the at least one of the shop terminal or the portable customer terminal is configured to receive an approval operation or a denial operation for the held payment processing when the predetermined notification is issued, and
wherein the at least one processor allows execution of the held payment processing when the approval operation is received, and prohibits execution of the held payment processing when the denial operation is received.

4-5. (canceled)

6. The payment system according to claim 1,
wherein the shop terminal and the portable customer terminal each include a GPS sensor, and
wherein the at least one processor acquires, as the shop terminal position information, position information detected by the GPS sensor of the shop terminal, and acquires, as the customer terminal position information, position information detected by the GPS sensor of the portable customer terminal.

7. The payment system according to claim 6, wherein the at least one processor determines the threshold value based on an intensity of a signal received by the GPS sensor of the shop terminal and an intensity of a signal received by the GPS sensor of the portable customer terminal.

8. The payment system according to claim 1,
wherein the shop terminal and the portable customer terminal each include at least one type of position detector, and
wherein the at least one processor determines the threshold value based on a type of the position detector of the shop terminal, which has detected the shop terminal position information, and a type of the position detector of the portable customer terminal, which has detected the customer terminal position information.

9. The payment system according to claim 1, wherein the at least one processor makes an inquiry as to whether to execute the payment processing in at least one of the shop terminal or the portable customer terminal when at least one of the shop terminal position information or the customer terminal position information has failed to be acquired,
wherein the at least one of the shop terminal or the portable customer terminal is configured to receive an approval operation or a denial operation for the payment processing when an inquiry has been made, and
wherein the at least one processor allows execution of the payment processing when the approval operation is received, and prohibit execution of the payment processing when the denial operation is received.

10. The payment system according to claim 1,
wherein the shop terminal and the portable customer terminal perform short-range wireless communication,
wherein the at least one processor:
determines whether the shop terminal and the portable customer terminal to perform short-range wireless communication when at least one of the shop terminal position information or the customer terminal position information has failed to be acquired, and
executes for the payment processing based on a result of determination when at least one of the shop terminal position information or the customer terminal position information has failed to be acquired.

11. A payment method, comprising:
acquiring shop terminal position information for indicating a position of a shop terminal when a portable customer terminal reads code information for identifying the shop, the code information being displayed in the shop terminal;
acquiring customer terminal position information for indicating a position of the portable customer terminal;
determining whether a distance between the position of the shop terminal indicated by the shop terminal position information and the position of the portable customer terminal indicated by the customer terminal position information is smaller than a threshold value; and
executing payment processing for the shop based on a result of the determination.

12. A. non-transitory computer-readable information storage medium for storing a program for causing a computer to:
acquire shop terminal position information for indicating a position of a shop terminal when a portable customer terminal reads code information for identifying the shop, the code information being displayed in the shop terminal;
acquire customer terminal position information for indicating a position of the portable customer terminal;
determine whether a distance between the position of the shop terminal indicated by the shop terminal position information and the position of the portable customer terminal indicated by the customer terminal position information is smaller than a threshold value: and
execute payment processing for the shop based on a result of the determination.
